(19) United States
(12) Patent Application Publication
(10) Pub. No.: US 2003/0150327 A1
(43) Pub. Date: Aug. 14, 2003

(54) HEPA filtration unit

(76) Inventor: Kurt E. Bolden, Cicero, IN (US)

Correspondence Address: Joseph A. Naughton, Woodard, Emhardt, Naughton, Moriarty and McNett, Bank One Center/Tower, 111 Monument Circle, Suite 3700, Indianapolis, IN, 46204-5137, US

(21) Appl. No.: 10/075,958

(22) Filed: Feb. 14, 2002

(51) Int. Cl. B01D 46/00

(52) U.S. Cl. 95/273; 55/356; 55/357; 55/385.3; 55/467

(57) ABSTRACT

A portable HEPA filter chamber is provided with a pair of wheels and a handle whereby it can be moved by a person in the manner of a two-wheeled hand-truck. One or more inlet openings receive air from an area to be cleaned, dried, or decontaminated. An air outlet is adaptable to the air inlet height of standard, widely-used carpet dryer blowers. Pre-filters are provided in the portable chamber upstream of the HEPA filter. Strapping holds the blower unit to the outlet of the filter chamber. Support wheels and a handle enable convenient hand-truck type operation to facilitate movement of the combination when and as needed in the area being dried. An upstanding perimeter flange, and the handle, when retracted, serve as a fence to stabilize multiple chambers, when stacked for storage or transportation in a truck. The exterior wall of the chamber is shaped for inter-fitting with others to minimize floor space for storage and transporting. Hook-on adjustable air flow inlet valves are usable for mold remediation operations.

### BACKGROUND OF THE INVENTION

This invention relates generally to structural drying work such as, for example, the drying of flooded areas of houses, offices, and other spaces.

### BRIEF DESCRIPTION OF PRIOR ART

For restoration of interior spaces which have been flooded, widely used procedures include portable dehumidifiers and portable carpet-dryer blowers. These machines are powered by electric motors which can be plugged into readily available electric outlets in the structure. For many years, contractors in the field of building demolition have been concerned about dust in general, particularly asbestos. Similarly, contractors in the field of flood damage control and remediation, have been concerned with drying areas and the contents therein. These contractors and workers in healthcare fields and in the insurance industry have been particularly concerned with addressing mold problems.

In the course of flood damage control and remediation activity, there has been increasing usage of high efficiency particulate air (HEPA) filters. Several systems suggesting the use of such filters have been made the subject of U.S. patents. Those known to me include a U.S. Pat. No. 5,417,729 to Greenleaf and which discloses a portable blower unit with a separable HEPA filter assembly and removable pre-filter. U.S. Pat. No. 4,968,333 to Ellis et al. discloses a portable primary filter unit and a portable blower and final filter unit containing HEPA filter units. U.S. Pat. No. 4,838,910 to Stollenwerk et al. discloses a portable blower unit with a separate HEPA filter unit. The Natale U.S. Pat. No. 4,613,348 discloses a HEPA filter-containing canister with a vacuum motor assembly mounted to the top of the canister, or a separate vacuum cleaner device with a suction hose connected to the canister. Other patented devices which have been brought to my attention are known and will be identified in an Information Disclosure Statement to be filed with or following the filing of this application. It is an object of my invention to provide a HEPA filter system that can be conveniently and effectively used by those working in the field of structural interior drying and/or mold remediation work.

### SUMMARY OF THE INVENTION

Described briefly, according to a typical embodiment of the present invention, a portable HEPA filter chamber is provided with wheels and a handle whereby it can be moved easily by a person from place-to-place in the way that a two-wheeled hand-truck can be moved. It includes one or more inlet openings for entry of air from an area to be cleaned, dried, or decontaminated. It has an air outlet adapted to connection to a standard, widely used carpet-dryer blower. Pre-filtering is provided in the portable chamber, upstream of the HEPA filter. Means are provided to conveniently anchor and seal the air intake of a separate and conventional carpet-dryer blower to the air outlet of the filter chamber. Means are provided to conveniently adapt the chamber outlet to different size blower inlets. Means are also provided on the chamber to facilitate convenient stacking and storing multiple chambers, when not in use. Means are provided on the chamber inlets to enable the user to easily attach a hose to an inlet, or to connect an inlet to a mold containment room without the use of a hose. Means are provided to adjust air flow into the chamber if, and as, desired.

### BRIEF DESCRIPTION OF THE DRAWINGS

FIG. 1 is a side elevational view of the HEPA filtration chamber connected to a conventional carpet-dryer blower, the latter being shown in broken lines.

FIG. 2 is a top plan view of the combination.

FIG. 3 is a front view thereof.

FIG. 4 is a fragmentary front view, but omitting the showing of the blower, to better show the height adjustment capability of the outlet snout.

FIG. 5 is a rear elevational view of the chamber without the blower.

FIG. 6A is a front view of the adjustable air flow ring valve assembly for mounting to the inlet openings on the back of the chamber.

FIG. 6B is a section through the ring assembly taken at line 6B-6B in FIG. 6A and viewed in the direction of the arrows.

FIG. 7A is a front view of the outlet cap assembly.

FIG. 7B is a section through the cap assembly taken at line 7B-7B in FIG. 7A and viewed in the direction of the arrows.

FIG. 8 is a top view of a group of three units demonstrating the interfitting feature of the side walls for storage.

### DESCRIPTION OF THE PREFERRED EMBODIMENT

For the purposes of promoting an understanding of the principles of the invention, reference will now be made to the embodiment illustrated in the drawings, and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

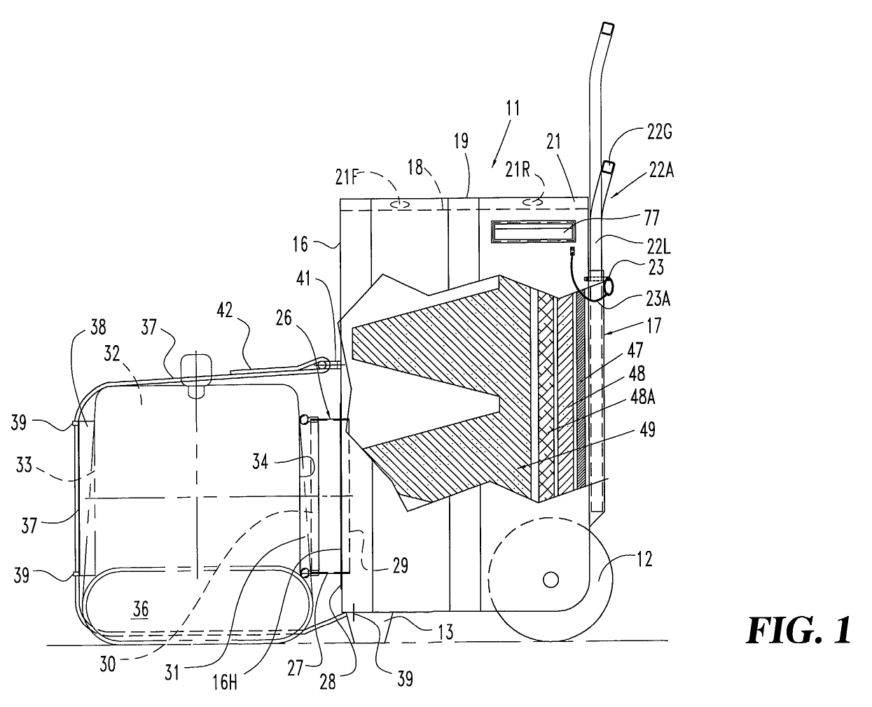

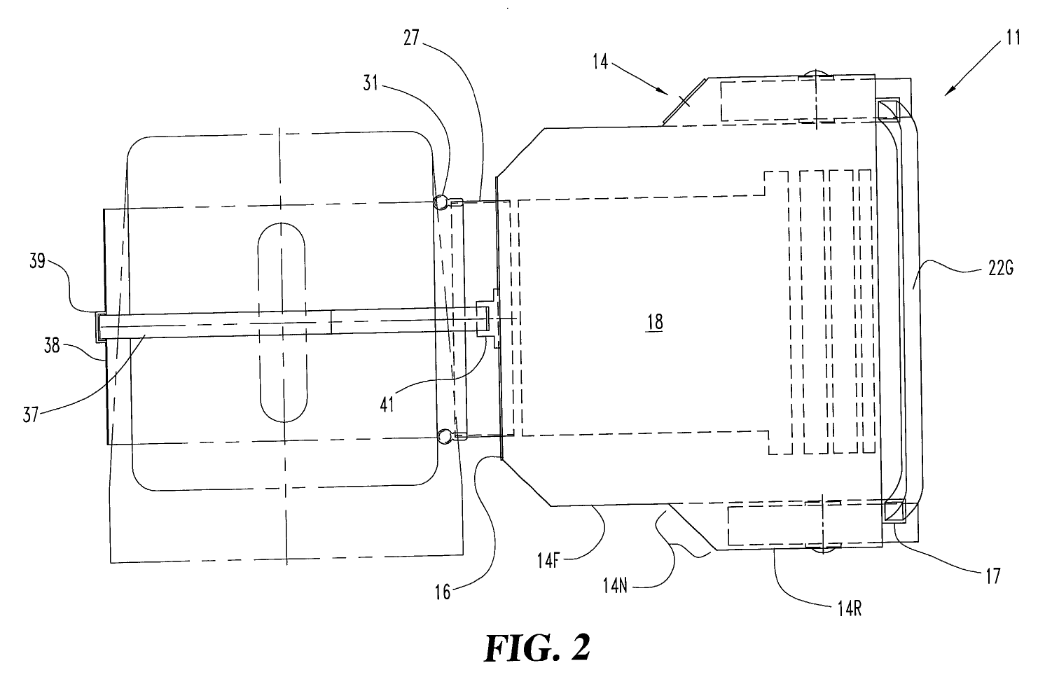

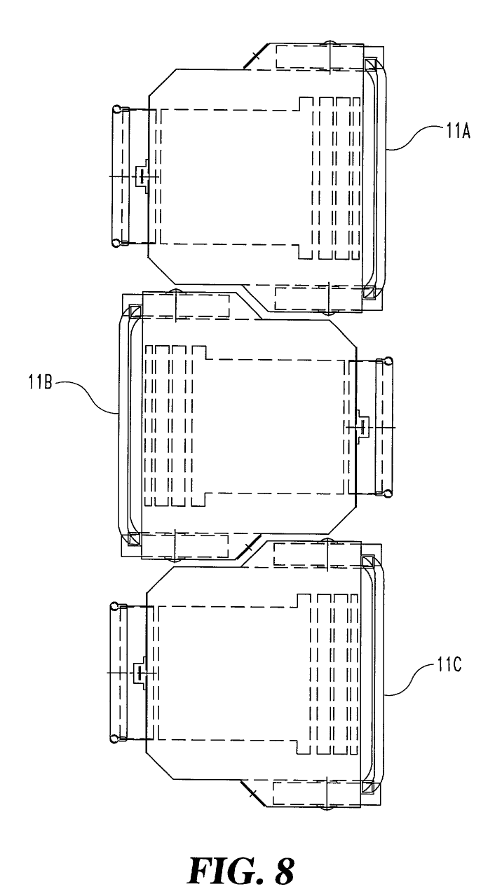

Referring now to FIG. 1, the illustrated filter chamber 11 includes a box fabricated preferably from stainless steel. It has two wheels 12 at the lower back corners, and a support leg 13 at the center of the front. It might be found preferable to have two support legs, one at each comer of the front. The leg and wheels have non-marring bottom and resilient tread material, respectively. As shown in the top plan view of FIG. 2, the side walls 14 are notched at 14N, providing offset rear side wall portions 14R and front side wall portions 14F. The notch 14N is half-way between the front wall 16 and rear wall 17. This construction enables the units to be placed side-by-side in interfitting relationship, by alternate units facing in opposite directions as shown in FIG. 8 for units 17A, 17B and 17C. This can be advantageous in a warehouse, a van, a “high cube” truck, or other vehicle, during storage or transportation, by minimizing the overall floor space requirement for storage of these chambers while not in use.

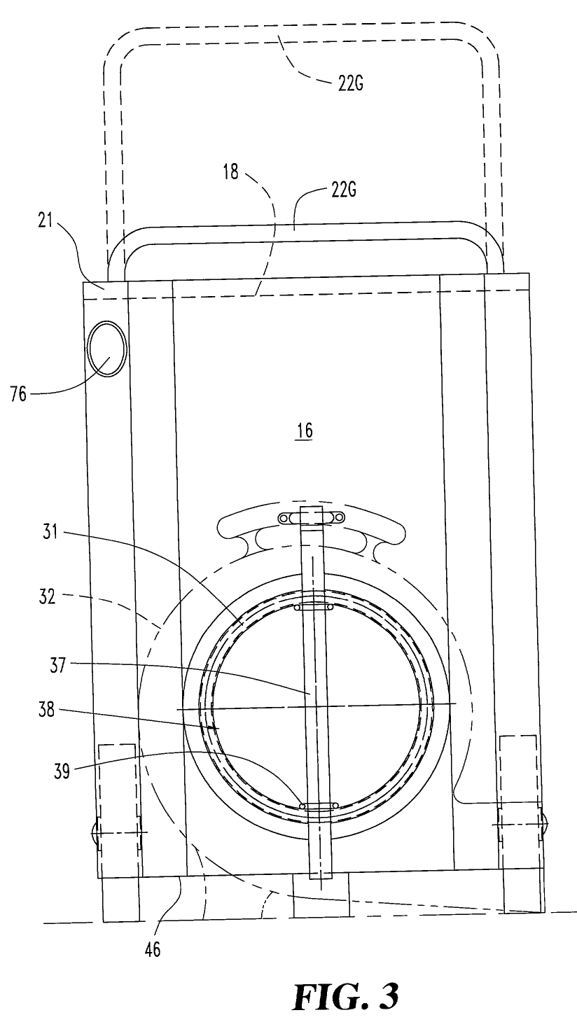

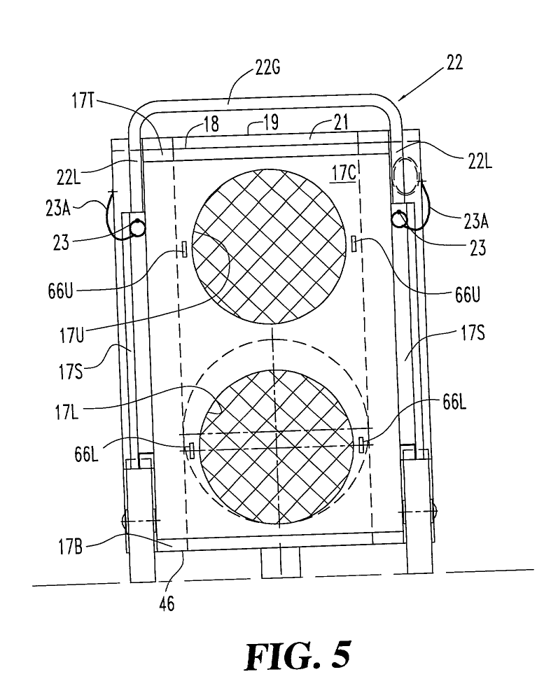

The chamber has a top 18 (FIGS. 2 and 5) and which is indicated by the dotted line in FIGS. 1 and 3 below the top edge 19 of the side and front walls. Therefore, there is an upstanding flange 21 around the sides and front of the chamber. This defines a “footprint” of fencing around an area that would be occupied by the leg 13 and wheels 12 of another identical chamber. As such, it enables the chambers to be stacked vertically, three units high, when not in use, to further conserve horizontal space in a warehouse, shop, or van-type vehicle.

A handle 22 is provided immediately inside the rear wall 17 and has horizontal bight portion 22G and downturned arms 22L received in tubes (not shown) formed on the inside of the rear wall portions 17S near the side wall portions 14R. Each of these arms has holes in the rear and receiving lock pins 23 that are secured by lanyards 23A, whereby the handle can be pulled upward from the recessed position shown by the solid lines in the figures, to the extended position shown by the broken lines in FIG. 3. When locked in the extended position, the handle is useful for moving the chamber across a floor in the manner of use of a conventional two-wheeled hand truck, by tipping it upward about the wheels and pushing or pulling it with hands gripping the bight portion 22G of the handle. As shown best in FIGS. 1 and 2, the upper portions of the handle arms are angled rearwardly at 22A. This feature enables the wheels 12 of another like chamber to neatly fit and be retained in place when the other chamber is stacked on the one chamber. In the above mentioned two-legged alternate embodiment, the legs can be in canted orientation to fit in the front comers of the canted portion 21F of the flange at the top front on each side of the chamber.

The front wall 16 of the chamber has a circular opening 16H therein receiving a snout 26 which is a fabricated unit including a cylinder 27 with a radially extending flange 28 welded to it and abutting the front wall 16. The cylinder 27 extends from flange 28 through the chamber front wall opening 16H to an inner (relative to the chamber) edge 29 of the cylinder inside the chamber. The cylinder 27 extends from flange 28 outward from the chamber to an outer edge 30. A bulb-type seal 31 is mounted and fixed to the outer edge of the snout cylinder 27. Typically the diameter of the snout cylinder is 10 inches.

A conventional carpet dryer blower assembly 32 is shown by the broken lines. It has a motor cooling inlet opening at 33 and air mover inlet opening 34 and discharge opening 36. This dryer is strapped to the outlet opening snout 26 of the filter chamber by a strap 37. In order for the blower to pull air only through the filter chamber, and not discharge unfiltered air from the blower outlet 36, the motor air inlet 33 is closed by a block-off plate and seal assembly 38 (FIGS. 1-3 and 7A and 7B). This plate has two loops 39 receiving the strap 37 through them. The lower end of the strap is anchored to the bottom front of the chamber at 39, being sandwiched between the bottom 46 of the chamber and the top of leg 13 which is bolted to the bottom 46 of the chamber. The strap is passed from this anchorage forward under the blower and up through the loops 39 in the block-off plate and up through a loop 41 on the chamber front wall 16, and back upon itself at 42, where it is snugged and anchored as by a clamp or, preferably, a hook-and-loop fastening system such as known by the brand name Velcro.

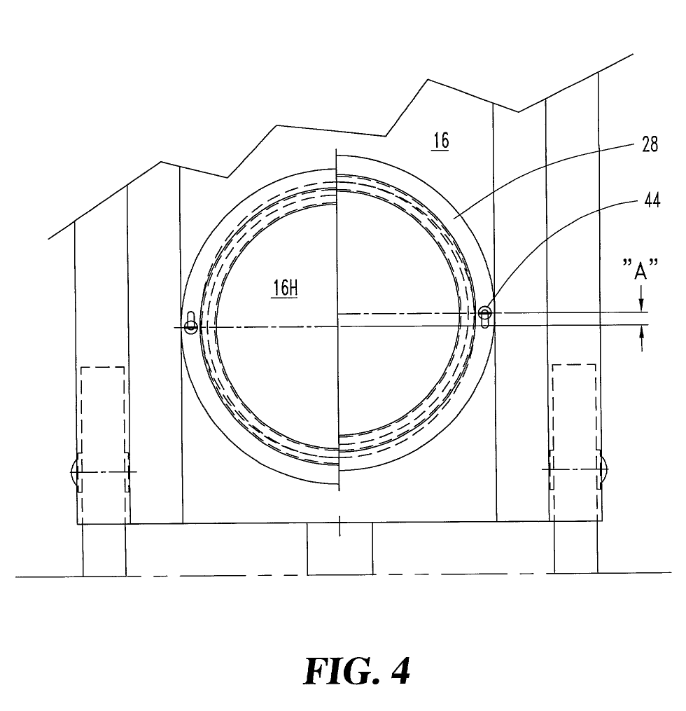

For passageway adaptation to different heights of inlet openings 34 of different brands of carpet dryer blowers, the snout assembly 26 can be moved up and down to a limited extent. In an example for the ten inch diameter snout, the front opening 16H in the wall 16 is large enough for vertical movement of the snout a total of 1.5 inches (dimension A in FIG. 4). This is accommodated by vertical slots in the front panel which receive two screws such as 44 received in two elastic lock nuts inside the wall and by which the flange 28 is secured to the front wall 16. FIG. 4 illustrates a total range of positions of the snout, the right-hand side of the illustration being the upper limit of the range, and the left-hand side of the illustration representing the lower limit. Of course, other ranges can be provided for by longer slots in either the front wall 16 or in the flange 28.

Referring now to FIGS. 5 and following, the back of the chamber comprises a central panel 17C which is readily removable, being confined at the sides by stiles 17S and at the top and bottom by rails 17T at the top and 17B at the bottom. The rail 17T at the top is a down-turned flange from the top panel 18. The rail 17B at the bottom is an upturned flange from the bottom panel 46 of the chamber. Panel 17C can be removed from the chamber by simply lifting it slightly, pulling the bottom edge out from confinement by the bottom rail 17B, and lowering it and pulling the panel out from the confinement by the top rail 17T. Upon removal of the back panel 17C, there is immediate and easy access to the filters. These may include a first pre-filter 47, a second two-stage carbon/poly pre-filter 48, a third two-stage activated carbon pre-filter 48A, and a rack containing the 99.97% HEPA filter 49. This arrangement can be most readily seen by viewing the breakout portion of the side wall of the chamber as shown in FIG. 1. The first pre-filter can easily be seen through the side breakout in FIG. 1 and through the two openings 17U and 17L in the removable panel 17C in FIG. 5. When the chamber is used in a room in a normal air scrubbing and drying application, these openings 17U and 17L may be exposed directly to the room environment. But for some applications, the present invention is quite useful for removing air and contaminants for a mold containment room. For example, if there is an area in a structure and which has been highly contaminated with mold, it is a typical practice to isolate the area where the mold is evident, by building a “containment room” of polyethylene film on some kind of framework. An opening is provided in a wall of the containment room to expose the area of mold to the interior of the containment room, having already taped all the way around the area to avoid any escape into the rest of the larger room in which the containment room is built. Then the user hooks-up a filter and blower combination of some sort to suck any mold spores and other contaminants through a filter for discharge from the blower. Governmental requirements are strict with regard to the amount of vacuum or negative air pressure permitted within the containment room during this process. The limit is five to seven Pascals of negative air pressure. With conventional equipment, it sometimes becomes necessary to cut a slot or slots in the plastic wall of the containment room to prevent conventional blower/filter combinations from pulling an excess vacuum. If, during a long period of treatment, there is a power loss due to a storm or a maintenance person unplugging the blower, there is no longer a vacuum in the chamber, with the resultant possibility of spores exiting through the slots in the containment room wall that were cut by the technician. In the case of the present invention, with the adjustable valves according to the present invention, and to be described now, there is no necessity for compromising the integrity of the containment room by cutting or punching slots or holes in it.

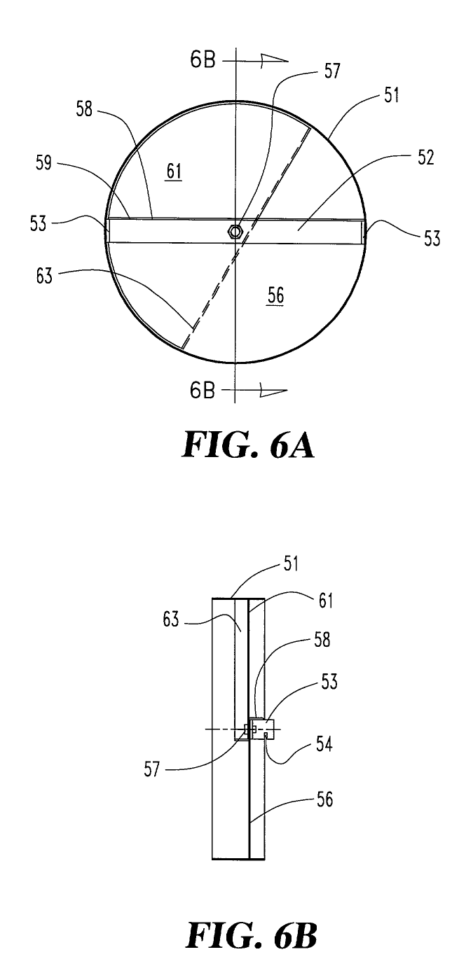

Referring now to FIG. 6A, this is a front view of one of the adjustable air flow valve assemblies, showing the face of the assembly which faces the interior of the chamber 11. As shown in this view and in FIG. 6B, the illustrated air flow ring 51 which may be a steel cylinder, has a web rail 52 across it and secured to the inner wall of the ring. This rail has an upturned portion at each end as at 53 and which has a downwardly opening notch 54 so that portion 53 can serve as a hook. A plate 56 is received on the back side of this rail and is fastened to it by a bolt 57 through the center of the plate and rail, and is prevented from turning inside the ring by a forwardly turned flange 58 engaging the upper edge 59 of the rail 52.

A plate 61, identical to plate 56, is mounted to bolt 57 behind plate 56 and can freely turn on bolt 57. It too has a flange such as 58 but it is turned backward and can be used as a handle or sort of knob to enable a technician to turn the plate 61 relative to 56 to any extent desired. Thus, the edge 63 of the rearwardly turned flange can be located anywhere from a position where it is precisely parallel to the flange 58, thus closing the ring entirely, to a position where it is again parallel to flange 58 but creates an opening which is fifty percent that of the hole in the panel in which the ring is mounted. The position shown in FIG. 6A is approximately sixty degrees open. When the desired adjustment has been made to reduce flow sufficiently to obtain the Pascal number usually between 5 and 7 desired for the containment room, the ring can be hooked onto the back panel 17C of the chamber by inserting the hooks 53 in the slots 66U provided at each side of the opening, such as 17U, whereupon the downwardly opening notch 54 of the hook engages the bottom of the slot 66U beside the opening to retain the air flow ring and valve assembly on the back panel of the chamber. The same construction with slots 66L is provided for the valve assembly for the lower opening 17L. Only one or both of these assemblies can be used and adjusted as desired for the particular size and requirements of the containment room to which they are attached, either directly or through flexible hose.

So it can be seen that, instead of cutting the wall of the containment room to get the desired negative pressure when coupled to a conventional blower, the throttle plates according to the present invention can be adjusted by the technician at the outset to provide the desired level of negative air pressure by simply closing the plates to the extent needed. If, after making an adjustment, it is found to be necessary to make a further adjustment, the valve assembly can be simply lifted off the back panel, adjustment made to the plates, and the valve assembly put back on the chamber. It is not necessary to provide a special seal or taping of the valve assembly to the chamber back panel because, any time that the containment chamber is hooked up to the operating filter/blower combination, the blower will be running and pulling air into the filter, whether the air comes from the area in which the blower/filter combination is located, or from the containment room.

The construction and mounting of the valve assemblies and their sizing makes it possible to readily connect standard, non-insulated flexible tubing snuggly fitting or taped to the outer surface of the valve assembly, with the other end of the tube sealed by tape to the wall of the containment room. Alternatively, the tubing can be eliminated and the plastic wall film of the containment room can be cut with two ten-inch diameter holes, and the valve assemblies taped tight to the film around the holes. Then the filter chamber can be backed up to the wall of the containment room and the valve assembly simply hooked in place on the back panel of the chamber.

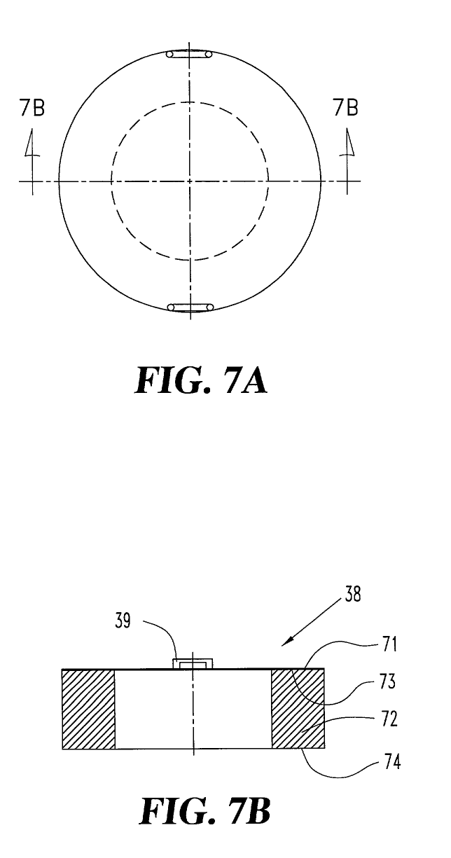

Referring now to FIGS. 7A and 7B, the cover plate 38 mentioned briefly above, includes the metal plate itself 71, to which loops 39 are affixed at diametrically opposed locations. It also includes a seal ring 72 of resilient closed-cell foam adhesively adhered to the back side of the plate at 73. The foam is typically three inches deep from the plate to the rear edge 74 of the foam and is of a diameter and shape compatible with the ten inch diameter opening 16H in the front wall 16 of the chamber to seal closed the chamber when the unit is not in use. It also appropriately fits the blower motor cooling air intake opening 33 of the blower assembly to plug that opening when the blower assembly and the chamber are strapped together for use in a drying job. The foam is a custom, die-cut non-permeable foam and, being flexible, will fit the contour of the motor and air intake without leakage. Regarding cover plate 38, once the blower has been removed, this cover plate with three inch seal can be strapped onto the front end of adapter 27 or directly onto front panel 16 and covers the clean side of the HEPA filter. This will prevent the clean side of the HEPA filter from contamination during removal from the job site and storage.

The illustrated HEPA filter assembly itself comprises a standard molded plastic filter rack stacked with 24×12×12, 99.97 percent HEPA filtering media as provided by the Air Handler Organization. It has a “mini-pleat, V-bank” configuration. HEPA-type filters of other manufacturers and configurations might be useful alternatives.

To conveniently carry the blower assembly from job-to-job along with the HEPA filter chamber at the same time, slots are provided at 21F and 21R (FIG. 1) in the upstanding flange or fence 21 of the chamber. Straps, preferably with hook-and-loop end portions are passed through these slots and over the blower when placed on top of the chamber for traveling. One of the straps passes through the slots 21R and is typically passed through the handle opening on the blower. The other strap is passed through the slots 21F and is strapped over the discharge snout of the blower. Thus, the top of the chamber serves as a transport and storage tray for the blower. In this way, the person handling the apparatus can easily transport both the chamber and the blower from place to place by rolling the combination along in the manner of a conventional hand-truck operation.

Finally, although not mentioned above, a ⅛^{th} inch thick soft rubber seal is typically glued or otherwise secured to the rear face of the front snout flange 28 to seal against the front face 16 of the chamber. An example of the bulb-type seal 31 is a push-on trim weather strip SKU#132X2565N as sold by J. C. Whitney, Inc. As mentioned above, to facilitate adaptation of this snout to different heights of blower intakes, the screws or bolts 44 are installed with their heads on the outside of the flange 28 and shafts passed through the slots 16S in the front of the chamber, and are held in place by suitable locknuts engaging the inside face of wall 16 and sufficiently snugged so as to enable moving the snout up or down as needed to adapt to the blower intake. Being locknuts, preferably of the elastic or plastic-insert type, they will not back off from vibration or otherwise during the passage of time. Also, the banding or strapping or belting can be of a variety of flexible materials, referred to herein as straps. The hook-and-loop features are most convenient.

Additional provisions can be provided such as a vacuum gauge at 76 and recessed lifting handles in the side walls as at 77 in FIG. 1. The assembly without the separate blower is about 32 inches high, 22 inches wide, and 20 inches deep. Its weight is between 30 and 40 pounds. Conventional carpet dryer blowers, “Tempest” brand or “Drieaz” brand or other brands having a housing with a carrying handle and having a blower fan or wheel and drive motor inside, can be used. The chamber will flow 900 to 1100 cubic feet of air per minute, depending on the blower strapped to it.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A portable filtering apparatus comprising:
a chamber having a front and a rear and a top and a bottom and an inlet for receiving air from an environment, and having an outlet for connection to a vacuum source, and having at least one air path from the inlet to the outlet;
a HEPA filter in the air path and oriented to remove impurities from all of the air passing through the chamber from the inlet to the outlet;
wheels on the chamber at the rear and projecting downward from the bottom to support the chamber at the rear;
at least one leg projecting downward from the bottom and at a location ahead of the wheels;
a handle projecting upward from the rear and co-operable with the wheels to enable a user to move the chamber from place-to-place in the manner of a two wheel hand truck.

2. The apparatus of claim 1 and wherein said handle is retractable.

3. The apparatus of claim 1 and wherein:
said air outlet has means for sealed communication with an air inlet of a conventional carpet-dryer blower.

4. The apparatus of claim 1 and further comprising:
an outlet adapter including a cylindrical tube having a front end and a rear end and a radially outward extending flange located between said ends, said flange being fastened to the front of the chamber, with a portion of the tube extending through said inlet into the chamber, and a portion of the tube extending outward from the flange to the front end of the tube.

5. The apparatus of claim 4 and further comprising:
a bulb seal around the front end of the tube for sealing connection to the inlet of a blower when connected to the chamber.

6. The apparatus of claim 4 and further comprising:
fasteners connecting the tube to the front of the chamber and including:
a stop nut engaging the inside of the front of the chamber; and
a threaded fastener engaging the flange of the tube and the stop nut and securing the flange to the front of the chamber.

7. The apparatus of claim 6 and further comprising:
a blower having an inlet and an outlet, the inlet being sealed to the tube; and
a belt secured to the front of the chamber and to the blower and securing the blower to the chamber.

8. The apparatus of claim 7 and further comprising
a second inlet on the blower;
a cap plugging the said second inlet on the blower;
the belt engaging the blower and securing the cap to the second inlet of the blower.

9. The apparatus of claim 7 and wherein;
the belt includes hook-and-loop fasteners thereon to maintain tension on the belt securing the blower to the chamber.

10. A portable filtering apparatus comprising:
a chamber having a front and a rear and a top and a bottom and an inlet for receiving air from an environment, and having an outlet for connection to a vacuum source, and having at least one air path from the inlet to the outlet:
a HEPA filter in the air path and oriented to remove impurities from all of the air passing through the chamber from the inlet to the outlet:
an air blower outside the chamber outlet and having an air inlet and an air outlet;
an adapter on the outlet of the chamber and having an inlet communicating with the interior of the chamber through the chamber outlet, and said adapter having an outlet engaged with the blower inlet whereby the blower, when operating, induces a flow of air into the chamber inlet and along the air path through the chamber to the chamber outlet and through the adapter and the blower to discharge through the blower outlet.

11. The apparatus of claim 10 and wherein:
the adapter is movable relative to the chamber while maintaining communication of the adapter inlet with the interior of the chamber through the chamber outlet.

12. The apparatus of claim 10 and further comprising:
a seal surface on the adapter outlet and engaging and sealing the adapter outlet to the blower inlet.

13. The apparatus of claim 12 and further comprising:
a strap connected to said chamber and to said blower and retaining said adapter outlet sealed to said blower inlet.

14. The apparatus of claim 12 and further comprising:
fasteners engaging said adapter and said chamber, securing said adapter to said chamber, said fasteners being vertically slidable on said chamber whereby the height of said adapter relative to said chamber is adaptable to the height of the blower inlet relative to said chamber.

15. The apparatus of claim 12 and further comprising:
a plate mounted to said blower and engaged by said strap and holding said blower against said adapter.

16. The apparatus of claim 12 and further comprising:
a first seal mounted to said adapter and engaging said blower to seal said blower to said adapter.

17. The apparatus of claim 16 and further comprising:
a second seal mounted to said adapter and to said chamber, and sealing said adapter to said chamber.

18. The apparatus of claim 16 and wherein:
said first seal is a bulb-type seal ring.

19. A portable filtering apparatus comprising:
a chamber having a front and a rear and a top and a bottom and an inlet for receiving air from an environment, and having an outlet for connection to a vacuum source, and having at least one air path from the inlet to the outlet;
a valve assembly mounted to the chamber at the outlet,
the valve assembly including a tube having a front end and a rear end;
hooks on the front end of the tube; and
apertures on the chamber receiving the hooks and retaining the tube on the chamber in communication with the chamber inlet opening.

20. The apparatus of claim 19 and further comprising:
a plate in said valve assembly and movable through a plurality of positions changing the area of the valve assembly permitting air to flow through said valve assembly into said chamber inlet.

21. The apparatus of claim 20 and wherein:
the outside diameter of said tube is about ten inches.

22. A portable filtering apparatus comprising:
a chamber having a front and a rear and a left side wall and a right side wall;
an air inlet in one of said walls;
an air outlet in another of said walls;
high efficiency particulate air filter media inside said chamber in the path of air flow from said inlet to said outlet;
the side walls having notches therein arranged to enable placing identical ones of said chambers side-by-side in inter-fitting relationship to reduce floor space occupied by a group of said chambers.

23. The apparatus of claim 22 and wherein:
said front and side walls project upward above the level of said top, thereby providing an upstanding flange around the front and side; and
said wheels and leg are immediately inboard of the footprint of the flange;
whereby identical ones of said chambers are stackable, with the flange of a lower chamber in a stack positioned to limit lateral movement of the next higher chamber in the stack and limit horizontal shifting of the higher chamber relative to the lower chamber in the stack.

24. The apparatus of claim 23 and further comprising:
an handle upstanding from the chamber at the rear and having a bridging portion from side to side and slightly rearward of the upward projection of the wheels;
whereby identical ones of said chambers are stackable with the bridging portion of the lower one of the chambers in a stack confining the wheels of the next higher chamber in the stack to limit rearward shifting of the next higher chamber in the stack.

25. The apparatus of claim 24 and wherein:
the shape and size of the top of the chamber are adapted to securely support the blower atop the chamber for transporting the chamber, with the blower on the top of the chamber, from place-to-place in the manner of operating a two-wheel hand truck.

26. The apparatus of claim 25 and further comprising:
anchors in the flanges for receiving straps to secure the blower to the top of the chamber during said transporting.

27. The apparatus of claim 19 and wherein:
the rear end of said valve assembly inlet is adapted to being taped directly to a mold containment enclosure to provide a sealed connection of said inlet valve assembly to such enclosure for communication of such enclosure with said chamber only through said valve assembly.

28. The apparatus of claim 15 and wherein:
said plate is sized to sealingly fit said adapter outlet.

29. The apparatus of claim 15 and wherein:
said plate is sized to sealingly fit said chamber outlet.

30. The apparatus of claim 15 and wherein:
said plate has two faces with a resilient seal on one face; and
a strap receiver loop on the other face.

31. A method for filtering air in a habitable room and comprising:
providing an air blower having a housing and an air inlet and an air outlet in the housing;
proving a filter chamber having an air inlet and an air outlet and at least one filter in an air flow path inside the chamber from the said air chamber inlet to said air chamber outlet;
strapping the blower to the outside of the chamber with the blower air inlet communicating with the chamber air outlet, and running the blower to induce air from the room into the chamber inlet and through the filter;
filtering the induced air in the filter, to provide filtered air;
inducing the filtered air from the chamber outlet into the blower air inlet; and
discharging filtered air from the blower air outlet.

32. The method of claim 31 and further comprising:
providing a passage adapter having an inlet and an outlet, with the adapter inlet around the chamber air outlet; and
sealing said adapter to said blower inlet and to said chamber outlet.

33. The method of claim 32 and further comprising:
moving the adapter vertically on the chamber so that, when the chamber and said blower are supported on a floor, the adapter outlet is aligned with the blower inlet.

34. The method of claim 32 and wherein:
the blower has a motor cooling air inlet, the method further comprising:
plugging the motor cooling air inlet.

35. The method of claim 34 and further comprising:
strapping a plug into the cooling air inlet for both plugging the cooling air inlet and strapping the blower to the chamber.

36. The method of claim 35 and further comprising:
turning off th e blower;
unstrapping the blower from the chamber;
removing the blower; and
strapping the plug into said adapter outlet to exclude environmental unfiltered air from a clean face of the filter.
